(19) United States
(12) Patent Application Publication
(10) Pub. No.: US 2024/0144212 A1
(43) Pub. Date: May 2, 2024

(54) SYSTEMS AND METHODS FOR RAIL-BASED GATEWAY LOGIC COMMUNICATIONS

(71) Applicant: CARBON ARC, New York, NY (US)

(72) Inventors: Marc F. BARBAR, New York, NY (US); Kirk D. MCKEOWN, New York, NY (US); Eileen K. MURRAY, New York, NY (US); Timothy R. WALSH, New York, NY (US)

(21) Appl. No.: 18/244,610

(22) Filed: Sep. 11, 2023

Related U.S. Application Data
(60) Provisional application No. 63/384,171, filed on Nov. 17, 2022.
(60) Provisional application No. 63/381,517, filed on Oct. 28, 2022.

(51) Int. Cl. G06Q 20/10; G06Q 20/22; G06Q 20/36; G06Q 20/38; G06Q 20/40

(52) U.S. Cl. CPC G06Q 20/108; G06Q 20/223; G06Q 20/367; G06Q 20/389; G06Q 20/4014

(57) ABSTRACT

Disclosed are systems and methods that provide a novel electronic transfer framework that enables the sharing, control and hosting of electronic information via existing banking (or payment) rails. The disclosed framework can realize a newly formed, scalable relational-based database system that enables entities and systems to realize novel mechanisms for mapping between and among each other. HyperText Transfer Protocol (HTTP) iterations can be leveraged over the banking rails so as to enable operational node-based engagements between entities via the secure banking rails. Accordingly, the disclosed systems and methods enable the usage of the banking rails payment gateway logic to control and/or enable the access to entity's data. Therefore, in addition to the newly created ways of handling and processing data, the disclosed framework can evidence an increase in the computational efficiency online systems operate, while maintaining a security and governance level compliant with applied policies.

### CROSS-REFERENCE TO RELATED APPLICATIONS

This application claims the benefit of priority from U.S. Provisional Application No. 63/384,171, filed Nov. 17, 2022, which is incorporated herein in its entirety by reference. This application further claims the benefit of priority from and is related to U.S. Provisional Patent Application No. 63/381,517, filed Oct. 28, 2022, which is incorporated herein in its entirety by reference.

### FIELD OF THE DISCLOSURE

The present disclosure is generally related to the electronic transfer of electronic information, and more particularly, related to the real-time (or near real-time) electronic transfer of electronic information via payment/banking rails.

### BACKGROUND

A payment rail is a platform, network (virtual network) and/or infrastructure that enables the transfer of digital money (or allows digital money transfers) to be made between payers and payees, regardless of country, currency, digital payment method, or whether the payer or payee is a business or consumer.

### SUMMARY OF THE DISCLOSURE

Currently, the most popular payment rails (or banking rails, used interchangeably) include, but are not limited to, Automated Clearing House (ACH), Mastercard®, VISA® (and other major credit card (CC) rails and providers), PayPal®, the Real-Time Payments (RTP) Network, Blockchain, Society of Worldwide Interbank Financial Telecommunication (SWIFT), and Single Euro Payments Area (SEPA).

The ACH network is one of the most popular rails worldwide for online payments, and includes transaction categories such as bill payments, brokerage account deposits and direct payroll deposits. According to some embodiments, each ACH transaction has three core steps: i) the party requesting the transfer sends their bank a copy of the transaction details; ii) the bank sends these details to the central clearinghouse in the ACH Network; and iii) once these details reach the clearinghouse, the bank will be notified, and the proper accounts will be debited or credited.

Accordingly, for ACH, a bank may act as the Originating Depository Financial Institution (ODFI) for all ACH transactions, which are bank transfers. The responsibility for verifying the reality of the bank account and the presence of sufficient funds to fulfill the transfer falls to the individual or company transferring the funds.

Credit cards provide another form of payment rails platform (e.g., CC rails), and they operate on an independent network operated by companies that provide the technology for the transactions. For example, VISA®, Mastercard®, American Express® and Discover®. These card networks can charge merchant fees to process payments using their provided infrastructures.

According to some embodiments, the CC rail networks can provide real-time payment transfer processing that allows for faster payment settlement (than ACH, for example). In some embodiments, the credit card rails can enable a push-to-card framework that enables the instantaneous direct transfer of digital money to a debit card (or debit account). According to some embodiments, credit card rail infrastructures enable transactions to flow through the card network, from the merchant's acquirer or payment processor to the consumer's issuing bank in real-time.

Global payments company PayPal® allows customers to register an account with an email address connected to the user's card or bank account. When identification and proof of funds are confirmed, users can begin sending or receiving payments to and from other PayPal accounts online or through an application (or “app”).

RTP payment processing network enables the electronic and instantaneous transfer of digital money between banks. RTP is based on a liquidity model in which member financial institutions are required to maintain a minimum account balance with the Federal Reserve in order to ensure immediate funds transfer. The RTP network will immediately decrease the sender's financial institution's balance and boost the receiver's financial institution's balance once a transaction has been completed.

Blockchain is an auditable, distributed database that is shared across several computers linked together in a peer-to-peer (P2P) network. Blockchains maintain a secure and decentralized record of transactions in cryptocurrency systems like Bitcoin and Ethereum. Blockchains allow digital information to be recorded and distributed, but not edited. Blockchain guarantees the fidelity and security of a record of data and generates trust without the need for a trusted third party.

SWIFT is a cooperative society providing services related to executing financial transactions and payments between banks worldwide. SWIFT is a messaging network that operates as a carrier of payment instructions between financial institutions participating in a transaction. SWIFT communicates transaction orders between these institutions using SWIFT codes.

SEPA is a framework of transactions that harmonizes the way cashless payments are transacted between European countries. SEPA aims to make cross-border electronic payments as inexpensive and easy as payments within one country. European consumers, government agents, and businesses that make payments by direct debit, instant card transfer, and credit transfers use the SEPA architecture. SEPA bank transfers can be in three types: i) credit transfer; ii) instant credit transfer; and iii) direction debit transfer.

Conventionally, systems, which can correspond to companies, network and/or service providers, websites, portals, applications, users and the like, transact data via HyperText Transfer Protocol (HTTP). This, as one of ordinary skill in the art would understand, has become the standard for communicating, downloading, controlling, and sharing electronic information on the internet as a byproduct of supporting advertising technologies (e.g., online, internet, digital and/or web advertising), which uses the internet, via HTTP functionality, to promote products and services to audiences and platforms of users.

Effectively, the current version of HTTP (e.g., HTTP/3) uses a multiplexed transport protocol built on user data protocol (UDP, which is a core communication protocol for sending messages to other hosts on an Internet Protocol (IP) network). Everything from on-prem, hybrid and cloud infrastructures utilize the current forms of HTTP. Essentially, the entire current iteration of the internet is executing on a platform built for advertising, which runs on a database and mapping system that links webpages to network resources to ads.

As one of ordinary skill in the art would recognize, this effectively has its limits. That is, the speed, security and nature of electronic information transfers are governed by a system that was not built for such purposes. Even under current HTTP (i.e., HTTP/3), which enables communications to commence without first receiving header versions and removes the required handshaking of Transmission Control Protocol (TCP), there is a limit to the speed and security in which data can be shared, mapped to entities, and controlled via security protocols and governance policy, inter alia.

As such, the disclosed systems and methods provide a novel electronic transfer framework that enables the sharing, control and hosting of electronic information via existing banking rails. As discussed herein, in some embodiments, the disclosed framework provides a novel standardized mechanism(s) for exchanging value. Indeed, data can be treated as an entity on the network, and mapped to specific network locations for transfer, hosting and access, which can be provided by the disclosed framework's implementation of existing banking rails. There is currently no system that operates in such manner, let alone a system that can effectuate ethe speed and security of the disclosed electronic transactions.

As discussed herein, the disclosed framework can realize a newly formed, scalable relational-based database system that enables entities and systems to realize novel mechanisms for mapping between and among each other. According to some embodiments, as discussed herein, the novel ways data can be shared and mapped to entities can be realized via the usage of the existing banking rails. Accordingly, in some embodiments, HTTP protocols can be leveraged over the banking rails so as to enable operational node-based engagements between entities via the secure banking rails. Moreover, as discussed herein, according to some embodiments, the disclosed systems and methods enable the usage of the banking rails payment gateway logic to control and/or enable the access to entity's data.

By way of a non-limiting example, a credit card rail, such as, for example, VISA®, can execute a transaction of digital money (e.g., transfer of electronic account information) as follows: i) when a customer presents a card or other digital means of payment at a merchant, that transaction goes first to the acquiring bank; ii) once the acquiring bank receives the payment transaction, it routes it to the issuing bank on the consumer end of the transaction through the card network; iii) when the issuing bank receives a transaction, it reviews that consumer's account to ensure that they have enough funds or available credit. If so, it authorizes the transaction; and iv) the issuing bank then routes the transaction back through the card networks to the acquiring bank. The acquiring bank accepts the movement of funds from the consumer's account at the issuing bank into the merchant's account.

Such real-time processing can be performed within nanoseconds, whereby account information can be accessed, verified and transferred between entities. This type of processing is not capable of being performed (e.g., not as fast and not as secure) via existing advertising protocol models and infrastructure.

As such, according to some embodiments, the disclosed framework enables the mapping, sharing and hosting of electronic data by and between entities via such payment rail infrastructures. According to some embodiments, as discussed herein, the data shared can be of any type of known or to be known format and/or type, and can include, but is not limited to, an object, item, file, record, data structure, executable file/extension and/or container of data. In some embodiments, the data can be configured as any type of data model or data record, including, for example, a relational, dimensional, entity-relationship, hierarchical, network, object-orientated, physical, logical, multi-value, conceptual and the like.

Thus, for example, if user X is sharing data with user Y, where the data corresponds to a video file, the video file can be shared via a payment rail according to the disclosed systems and methods discussed herein, as provided for in more detail below. In another non-limiting example, if a user is streaming music from a streaming music service (e.g., Spotify®, for example), the user can receive the music via a payment rail according to the disclosed systems and methods while providing a unit of account for the streaming via the same and/or different rail, as discussed herein.

Accordingly, the disclosed systems and methods can provide almost instantaneous access to data, which is a game-changer for individuals or businesses that need data immediately. Real-time payment rails bring end-to-end (E2E) communication and instant confirmation notifications and settlement results, which can be leveraged for the secure communication and hosting of electronic data on a network (for example, business-to-business (B2B) transactions, as discussed below). Further, payment rail infrastructures foster innovation and create avenues for more business opportunities. This can additionally be leveraged by entities sharing their content and/or create new business dealings, as discussed herein. Moreover, according to some embodiments, with implementation of the payment rail infrastructures, companies/users can receive information faster, which improves business and information management, forecasting, and planning. Thus, using the latest digital and mobile technologies for customer convenience, reliability, and quick settlement, the disclosed framework's usage and implementation of payment rails as a basis for performing network operations and transactions can result in the next wave of innovation for the internet.

Therefore, in addition to the newly created ways of handling and processing data, the disclosed framework can evidence an increase in the computational efficiency online systems operate, while maintaining a security and governance level compliant with applied policies.

According to some embodiments, a method is disclosed for the electronic transfer of electronic information related to transactional data and data models via payment rails. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for a novel and improved framework for the electronic transfer of electronic information related to transactional data and data models via payment rails.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates a conventional network processing environment;

FIG. 4 illustrates an exemplary network processing environment according to some embodiments of the present disclosure;

FIG. 5 illustrates an exemplary data flow according to some embodiments of the present disclosure;

FIG. 6 depicts an exemplary implementation of a cloud computing architecture according to some embodiments of the present disclosure;

FIG. 7 depicts an exemplary implementation of a cloud computing architecture according to some embodiments of the present disclosure; and

FIG. 8 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router (WR) mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments will now be described in greater detail with reference to the figures. According to some embodiments, as evident from the instant disclosure, reference to data models, electronic data and/or entities transacting data (and data being treated as a mappable entity) may have corresponding disclosure in related U.S. Provisional Patent Application No. 63/381,517, filed Oct. 28, 2022, entitled “Computerized Systems and Methods For A Network-Based Data Modelling Platform.” As such, as mentioned above, such disclosure is incorporated herein by reference in its entirety and, in some embodiments, may form the basis for the created and transacted data/data models being stored, generated, shared, hosted and otherwise communicated over the payment rails, as discussed herein.

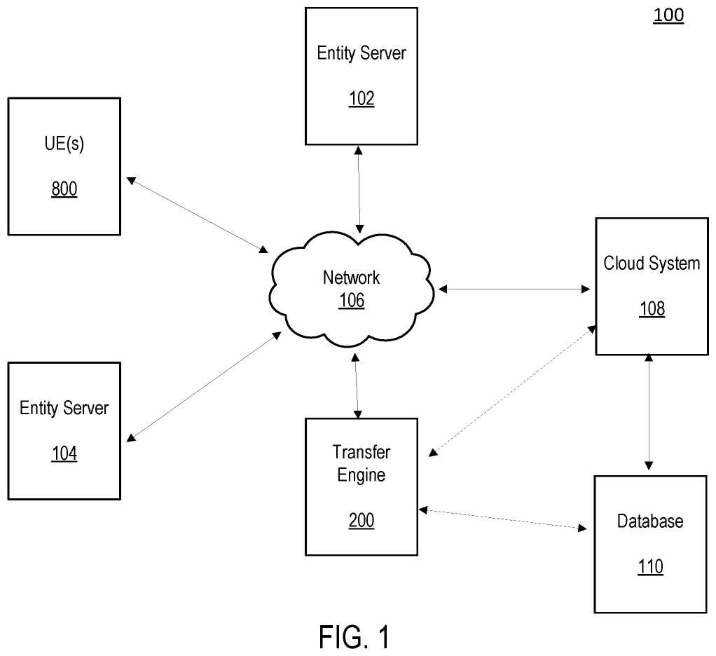

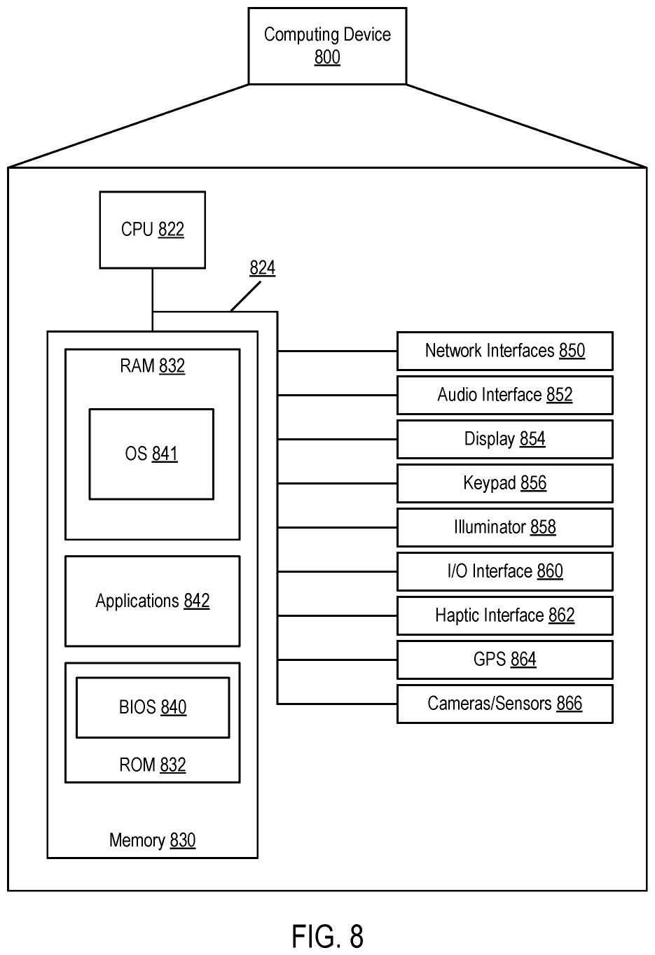

With reference to FIG. 1, system 100 is depicted which includes UE 800 (e.g., a client device, as mentioned above and discussed below in relation to FIG. 8), entity servers 102 and 104, network 106, cloud system 108, database 110 and transfer engine 200. It should be understood that while system 100 is depicted as including such components, it should not be construed as limiting, as one of ordinary skill in the art would readily understand that varying numbers of UEs, servers, cloud systems, databases and networks can be utilized; however, for purposes of explanation, system 100 is discussed in relation to the example depiction in FIG. 1.

According to some embodiments, UE 800 can be any type of device, such as, but not limited to, a mobile phone, tablet, laptop, sensor, Internet of Things (IoT) device, autonomous machine, and any other device equipped with a cellular or wireless or wired transceiver. In some embodiments, UE 800 can be associated with a user, entity, business, company, network, portal, and the like. In some embodiments, UE 800 can be associated with a user associated with entity server 102/104.

According to some embodiments, entity servers 102 and 104 correspond to a server(s) associated with an entity. It should be understood that each server 102 and 104 can be multiple servers, and can be any type of server, including, but not limited to, a banking server, gaming server, authentication server, search server, email server, social networking server, SMS server, IM server, MMS server, exchange server, enterprise server, music sharing server, photo-sharing server, travel server, and the like. Thus, the entities associated with servers 102 and 104 can be any type of entity, and be associated with any type of business. For example, entity 102 can be associated with a sports team (e.g., New York Knicks®), while entity 104 can be associated with a bank (e.g., Chase®). Thus, it should be understood that entity servers 102 and 104 are provided in system 100 to evidence that any type of entity (e.g., business, company, user, portal, and network, and the like — for example, banks, users, firms, people, accounts, applications, companies, governments, wallets, and the like, or some combination thereof) can be connected to network 106 and utilize the functionality provided by engine 200, as hosted by cloud system 108, as discussed herein.

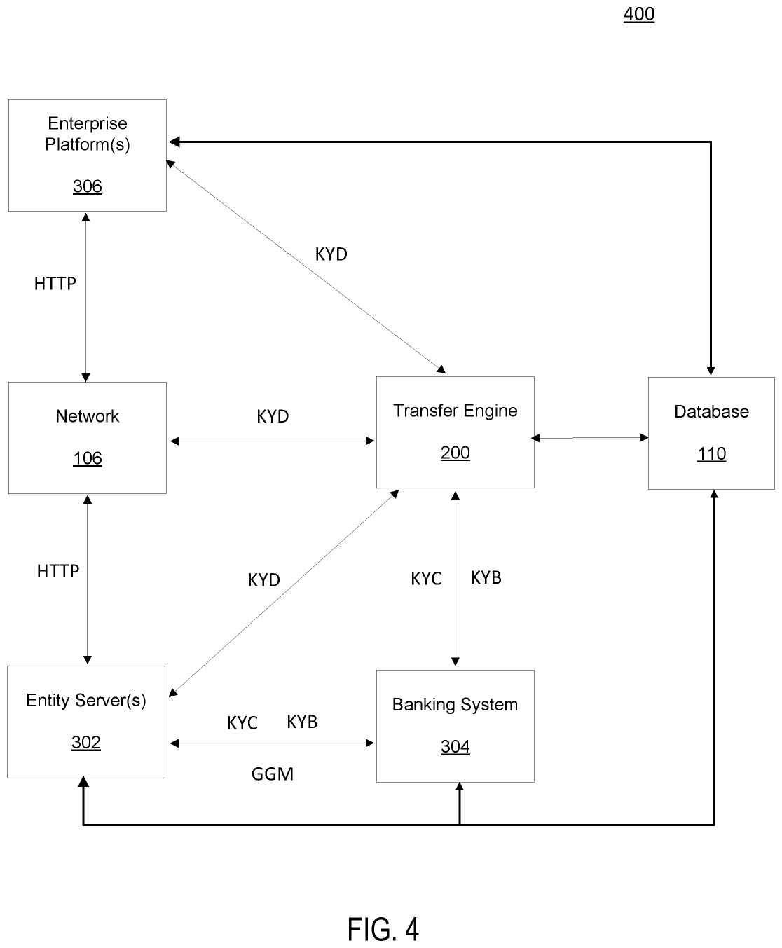

In some embodiments, network 106 can be any type of network, such as, but not limited to, a wireless network, cellular network, the Internet, and the like (as discussed above). Network 106 facilitates connectivity of the components of system 100, as illustrated in FIG. 1. According to some embodiments, as discussed in more detail below, network 106 can operate and/or integrate the payment/banking rails, as discussed above, so as to enable electronic transactions for and related to created, hosted and/or shared data/data models. For example, as discussed in more detail below, at least in relation to FIG. 4, network 106 can utilize engine 200 to perform an electronic transaction related to a data model between entity server 102 and entity server 104 via a payment rail (e.g., that is provided by banking system 304), discussed infra.

According to some embodiments, cloud system 108 may be any type of cloud operating platform and/or network based system upon which applications, operations, and/or other forms of network resources may be located. For example, system 108 may be a service provider and/or network provider from where services and/or applications may be accessed, sourced or executed from. For example, system 108 can represent the “Carbon Arc™” architecture hosted on the internet (e.g., network 106), which enables (via engine 200) the digital data asset factorization and management discussed herein.

For example, system 108 can provide UE 800 and/or entities 102-104 a programming interface that enables a search for data, whereby the search identifies a set of data that can be factorized and stored according to the disclosed systems and methods. In some embodiments, therefore, system 108 can host and/or provide a network resource that enables users access to engine 200′s capabilities—for example, the network resource can be a web page, web site, portal, application, and the like, or some combination thereof.

In some embodiments, cloud system 108 may include a server(s) and/or a database of information which is accessible over network 106. In some embodiments, a database 110 of cloud system 108 may store a dataset of data and metadata associated with local and/or network information related to a user(s) of UE 800 and the UE 800, entity servers 102 and 104, and the services and applications provided by cloud system 108 and/or transfer engine 200. In some embodiments, database 110 can be any type of known or to be known data storage on a network, including, but not limited to, a look-up table (LUT), a node on a network, an edge device, peer on a network, file storage, block storage, object storage, blockchain, object orientated database, distributed database, centralized database, and the like,

In some embodiments, for example, cloud system 108 can provide a private/proprietary management/settlement platform, whereby engine 200, discussed infra, corresponds to the novel functionality system 108 introduces, hosts and provides to a network 106 and other platforms operating thereon. Accordingly, according to at least some embodiments, system 108 may be configured to receive, handle, process, manage, monitor, settle and/or decline transaction requests to/from users and/or entities (e.g., entity servers 102 and 104).

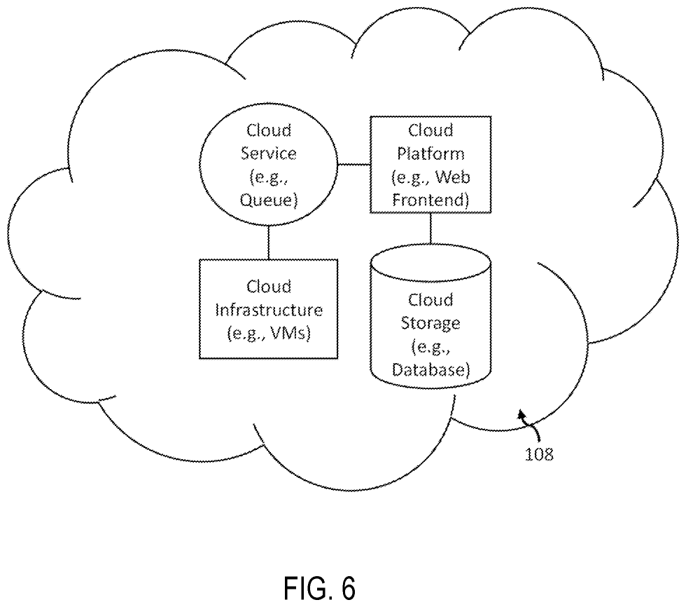

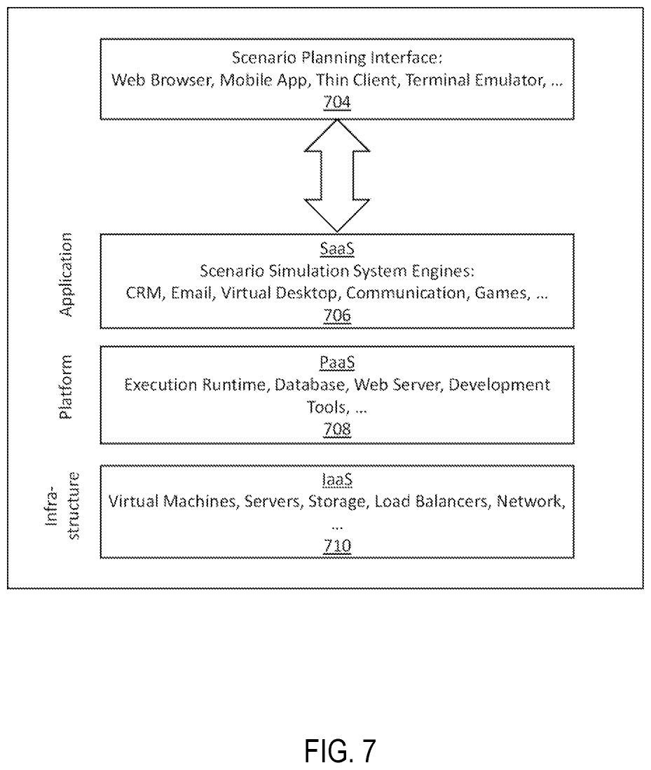

Turning to FIGS. 6 and 7, in some embodiments, the exemplary computer-based systems/platforms, the exemplary computer-based devices, and/or the exemplary computer-based components of the present disclosure may be specifically configured to operate in a cloud computing/architecture 108 such as, but not limiting to: infrastructure a service (IaaS) 710, platform as a service (PaaS) 708, and/or software as a service (SaaS) 706 using a web browser, mobile app, thin client, terminal emulator or other endpoint 704. FIGS. 6 and 7 illustrate schematics of exemplary implementations of the cloud computing/architecture(s) in which the exemplary inventive computer-based systems for administrative customizations and control of network-hosted and/or blockchain-related application program interfaces (APIs) via a workflow service (and/or microservice) of a blockchain environment of the present disclosure may be specifically configured to operate.

Turning back to FIG. 1, according to some embodiments, database 110 may correspond to a data storage for a platform (e.g., a network hosted platform, such as cloud system 108, as discussed supra) or a plurality of platforms. Database 110 may receive storage instructions/requests from, for example, engine 200 (and associated microservices), which may be in any type of known or to be known format, such as, for example, standard query language (SQL).

According to some embodiments, database 110 may correspond to a distributed ledger of a distributed network. In some embodiments, the distributed network may include a plurality of distributed network nodes, where each distributed network node includes and/or corresponds to a computing device associated with at least one entity (e.g., the entity associated with cloud system 108, for example, discussed supra). In some embodiments, each distributed network node may include at least one distributed network data store configured to store distributed network-based data objects for the at least one entity. For example, database 110 may correspond to a blockchain, where the distributed network-based data objects can include, but are not limited to, account information, entity identifying information, wallet information, device information, network information, credentials, security information, permissions, identifiers, smart contracts, transaction history, and the like, or any other type of known or to be known data/metadata related to an entity's structure, business and/or legal demographics, inter alia.

In some embodiments, a blockchain may include one or more private and/or private-permissioned cryptographically-protected, distributed databased such as, without limitation, a blockchain (distributed ledger technology), Ethereum (Ethereum Foundation, Zug, Switzerland), and/or other similar distributed data management technologies. For example, as utilized herein, the distributed database(s), such as distributed ledgers ensure the integrity of data by generating a digital chain of data blocks linked together by cryptographic hashes of the data records in the data blocks. For example, a cryptographic hash of at least a portion of data records within a first block, and, in some cases, combined with a portion of data records in previous blocks is used to generate the block address for a new digital identity block succeeding the first block. As an update to the data records stored in the one or more data blocks, a new data block is generated containing respective updated data records and linked to a preceding block with an address based upon a cryptographic hash of at least a portion of the data records in the preceding block. In other words, the linked blocks form a blockchain that inherently includes a traceable sequence of addresses that may be used to track the updates to the data records contained therein. The linked blocks (or blockchain) may be distributed among multiple network nodes within a computer network such that each node may maintain a copy of the blockchain. Malicious network nodes attempting to compromise the integrity of the database must recreate and redistribute the blockchain faster than the honest network nodes, which, in most cases, is computationally infeasible. In other words, data integrity is guaranteed by the virtue of multiple network nodes in a network having a copy of the same blockchain. In some embodiments, as utilized herein, a central trust authority for sensor data management may not be needed to vouch for the integrity of the distributed database hosted by multiple nodes in the network.

In some embodiments, exemplary distributed blockchain-type ledger implementations of the present disclosure with associated devices may be configured to affect transactions involving Bitcoins and other cryptocurrencies into one another and also into (or between) so-called FIAT money or FIAT currency, and vice versa.

In some embodiments, the exemplary distributed blockchain-type ledger implementations of the present disclosure with associated devices are configured to utilize smart contracts that are computer processes that facilitate, verify and/or enforce negotiation and/or performance of one or more particular activities among users/parties. For example, an exemplary smart contract may be configured to be partially or fully self-executing and/or self-enforcing. In some embodiments, the exemplary inventive asset-tokenized distributed blockchain-type ledger implementations of the present disclosure may utilize smart contract architecture that may be implemented by replicated asset registries and contract execution using cryptographic hash chains and Byzantine fault tolerant replication. For example, each node in a peer-to-peer network or blockchain distributed network may act as a title registry and escrow, thereby executing changes of ownership and implementing sets of predetermined rules that govern transactions on the network. For example, each node may also check the work of other nodes and in some cases, as noted above, function as miners or validators.

Transfer engine 200, as discussed above and further below in more detail, can include components for the disclosed functionality. According to some embodiments, transfer engine 200 may be a special purpose machine or processor, and can be hosted by a device on network 106, within cloud system 108 and/or on UE 800. In some embodiments, engine 200 may be hosted by a server and/or set of servers associated with cloud system 108.

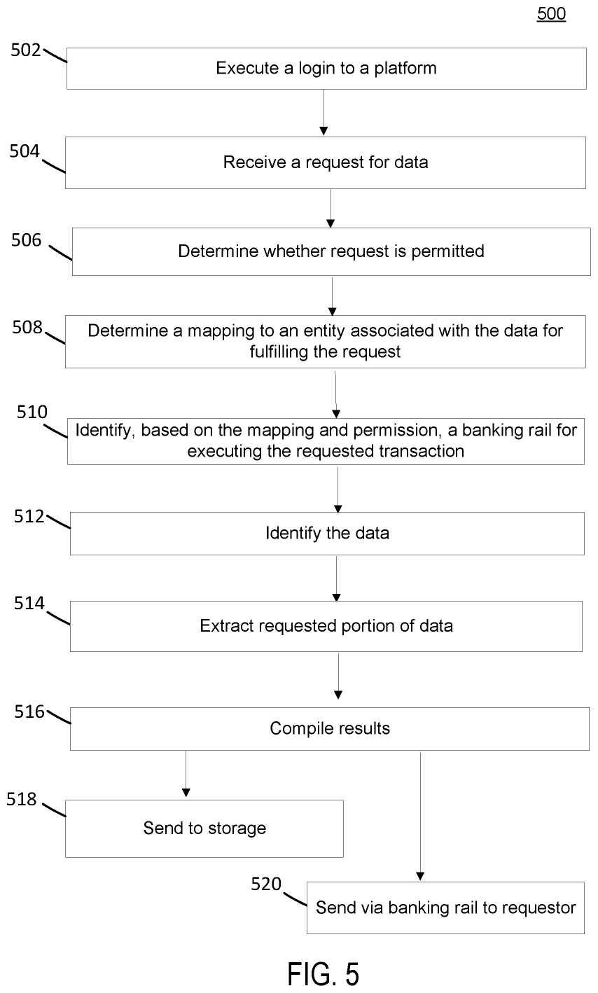

According to some embodiments, as discussed in more detail below, transfer engine 200 may be configured to implement and/or control a plurality of services and/or microservices, where each of the plurality of microservices are configured to execute a plurality of workflows associated with administering distributed network configurations defining a plurality of parameters associated with the plurality of distributed network data stores. Non-limiting embodiments of such workflows are provided below in relation to at least FIGS. 4-5.

According to some embodiments, as discussed above, transfer engine 200 may function as an application provided by cloud system 108. In some embodiments, engine 200 may function as an application installed on a server(s), network location and/or other type of network resource associated with system 108. In some embodiments, engine 200 may function as application installed and/or executing on UE 800 and/or entity servers 102 and/or 104. In some embodiments, such application may be a web-based application accessed by UE 800 and/or servers 102 and/or 104 over network 106 from cloud system 108 (e.g., as indicated by the connection between network 106 and engine 200). In some embodiments, engine 200 may be configured and/or installed as an augmenting script, program or application (e.g., a plug-in or extension) to another application or program provided by cloud system 108 and/or executing on UE 800 and/or servers 102-104.

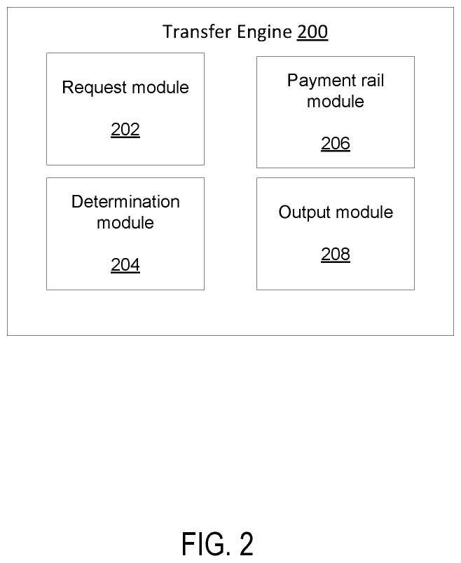

As illustrated in FIG. 2, according to some embodiments, transfer engine 200 includes request module 202, determination module 204, payment rail module 206 and output module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below in relation to FIGS. 4-5, inter alia.

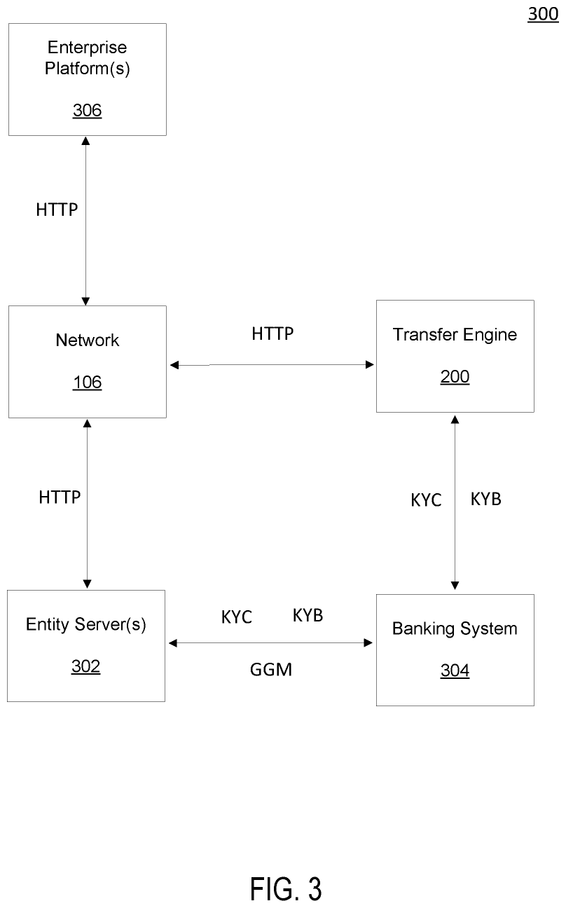

Turning to FIG. 3, provided is example configuration for electronic resource management (ERM) 300. The ERM 300 depicted in FIG. 3 includes network 106, entity server(s) 302, banking system 304, transfer engine 200 and enterprise platform 306. The illustrated ERM 300 corresponds to existing HTTP protocol utilized by the modern internet, which as discussed above, is based on and/or serves the purposes of providing advertising technologies.

According to some embodiments, enterprise platform 306 can refer to a set of integrated software applications and/or systems whose capabilities and shared data can be combined to create an enterprise business solution or application. Platform 306 can include and/or provide integral software for organizations that include, for example, businesses, schools, interest-based user groups, clubs, charities, and governments, and the like. In some embodiments, platform 306's software, therefore, be configured as a collection of computer programs that have common business applications, which can be configured as tools for modeling how an organization operates, and are aimed at providing functionality for business functions, such as, but not limited to, order processing, procurement, production scheduling, customer information management, energy management, and accounting, and the like, or some combination thereof.

According to some embodiments, entity server(s) 302 can correspond to at least one of the entity servers 102 and 104 discussed above in relation to FIG. 1. According to some embodiments, entity server 302, for example, can correspond to an entity, such as, but not limited to, a user (e.g., people), government, corporation, and the like, whereby each entity can have a separate server 302 associated therewith.

According to some embodiments, banking system 304 can correspond to the global banking system. In some embodiments, banking system 304 can correspond to a regional banking system (e.g., a system specifically used in the United States or Europe, for example). According to some embodiments, banking system 304 can correspond to, and/or involve the implementation via a set of financial institutions of the banking rails discussed above—for example, ACH, credit card (CC) rails (e.g., Mastercard®, VISA®, for example), PayPal®, the RTP Network, Blockchain, SWIFT, and SEPA, inter alia. Implementation of such rails is discussed below at least in relation to FIGS. 4 and 5.

According to some embodiments, by way of background, the communication by and between the components of ERM 300 can be effectuated via HTTP, know your customer (KYC), know your data (KYD) and know your business (KYB) protocols. Moreover, in some embodiments, the communications, particularly those by/between the entity server 302 and banking system 304 may be governed by laws and taxes, as discussed herein.

According to some embodiments, KYC protocol (or data) can correspond to the establishment of user identity, determination of the user's activities, verification of their legitimacy, and the like. KYC can provide a functional backbone for the disclosed framework from successful compliance and risk management perspectives.

According to some embodiments, KYD protocol (or data) can involve legal and compliance infrastructures associated with entities and associated events, as well as qualitive measurements of event validation and corresponding data. In some embodiments, KYD may correspond to and/or correlate with global grid monitor (GGM) functionality, which can control access to and audit any transformation and/or transfer of the data and environments where such data can and/or will be used. For example, GGM enables the implementation of jurisdictionally compliant privacy, terms of use governance and access control policies; in other words, the laws and taxes discussed above.

In some embodiments, GGM can involve the application of Data Sensitivity Tagging (DST) processing, whereby any Data Terms and Compliance (DTC) information can be attached to data being processed (e.g., transferred, stored, ingested and/or hosted, as discussed herein).

In some embodiments, the GGM can also provide information related to, but not limited to, distribution, computation, storage and custody information of data. Such information can correspond to, but is not limited to, blockchain based infrastructure information that correlates to regulatory information and protections that can mirror and/or enhance currently applied security protocols (e.g., encryptions and/or data privacy protocols associated with how certain types of data can be processed).

According to some embodiments, KYB protocol provides a verification process for business that is similar to KYC. In some embodiments, most business-to-business (B2B) companies can carry out due diligence with other businesses via KYB protocol, so as to, for example, fight money laundering and other tax crimes, in addition to ensuring that they work with organizations with security and guarantees. In some embodiments, KYB can provide data related to (in some embodiments, via the KYD) anti-money laundering (AML), general data protection regulation (GDPR), compliance for businesses.

Accordingly, under EMR 300, as depicted in FIG. 3, enterprise platform 306 can communicate, via network 106, with engine 200 and entity server(s) 302 via HTTP protocol, as discussed above.

Entity server 302 can communicate with banking system 304 via GGM protocol (e.g., in compliance with the applicable laws and taxes). For example, the GGM protocol can restrict whether data can be shared across state, country and/or other dividing lines that delineate governing laws.

In some embodiments, as illustrated in FIG. 3, when entity server 302 corresponds to and/or acts in accordance with activity associated with a person, then the communication with banking system 304 can be in accordance with KYC protocol. Similarly, when server 302 is transacting operations for a business, KYB protocol can be implemented. Moreover, engine 200 is operating respective to a person with regard to system 304, then KYC protocol is implemented; and when engine 200 is operating respective a business entity, then KYB protocol is implemented for the transaction with the system 304.

According to some embodiments, engine 200 can operate to effectuate transactions over network 106; however, such configuration and implementation of ERM 300 would not avail the transacting users to the novelty of utilizing the banking rails, as provided via ERM 400. Indeed, ERM 300 does not utilize KYD protocol/data, as does ERM 400.

As such, as depicted in FIG. 4, ERM 400 provides non-limiting example embodiments of the novel implementation of usage of the banking rails to execute data related transactions, as discussed herein. According to some embodiments, ERM 400 provides a network infrastructure that leverages global banking economies of scale and accepted banking systems of record to program the data layer of the internet (e.g., network 106 in FIG. 4, for example) with a globally scaled and hyper-contextually aware relationship database system.

According to some embodiments, as depicted in FIG. 4, engine 200 (which can be associated with, hosted by and/or executing thereon cloud system 108, as discussed above) can communicate with platform(s) 306, network 106, and server(s) 302 via KYD protocol. In some embodiments, database 110 can be a blockchain based KYD database, whereby, KYD protocols can govern how the data is stored and communicated by/between platform(s) 306 and server(s) 302.

In some embodiments, KYD can provide information related to compliance of, but not limited to, California consumer privacy act (CCPA), GDPR, office of foreign assets control (OFAC), AML, and the like.

In some embodiments, KYD protocols enable a relational element of data and mapping between entities in ERM 400 to be discovered, which enables the usage of the banking rails for real-time, novel transactional processing of data. In some embodiments, KYD enables the mapping that avails the network 106 to use the payment rails. That is, according to some embodiments, by leveraging KYD, the disclosed framework can operate to execute transactions between entities over network 106 via HTTP executing over payment rails—for example, using existing credit card rails to verify, initiate and securely execute the transfer of data with a previously unattainable speed and security (that is provided by ERM 300, discussed above).

According to some embodiments, as discussed herein, engine 200 can provide and/or execute KYC, KYD and KYB tokens and KYC, KYD and KYB APIs that enable the sharing of electronic data via the payment rails. Accordingly, information related to such tokens and API access and execution can be stored in database 110, which can be stored in association with each entity (e.g., person or business, for example), and/or identifying information (e.g., demographics, geographics, for example—which can further be related to GGM data).

FIG. 5 provides Process 500 which details non-limiting example embodiments for executing an electronic transaction related to the retrieval and sharing of electronic data. According to some embodiments, Steps 502-504 of Process 500 can be performed by request module 202 of transfer engine 200; Steps 506-508 can be performed by determination module 204; Steps 510-516 can be performed by payment rail module 206; and Steps 518-520 can be performed by output module 208.

According to some embodiments, Process 500 begins with Step 502 where engine 200 receives a request from a user to login to a system. According to some embodiments, the system can correspond to a platform, portal, application, or other type of service that avails the user to the capabilities for transacting data over the payment rails (or banking rails, used interchangeably, as discussed above), and, among other features, creating data models. According to some embodiments, Step 502 can involve engine 200 instituting an identity verification step that verifies the user's identity prior to the user engaging the platform. In some embodiments, such verification protocol can involve, but is not limited to, a username, password, PIN, alphanumeric code, biometrics, facial recognition, voice recognition, two-factor authorization, backend-as-a-service (BaaS) models, virtual card software (e.g., Marqueta) and the like, and/or any other type of known or to be known verification mechanism.

In some embodiments, Step 502 may involve a user establishing an account with a service or the platform, for example, with a BaaS provider. This account can be utilized to login to the system, and can further be configured to enable the transactional processing discussed herein.

In some embodiments, a verified login with the user can involve, but is not limited to, generating, initiating and/or activating tokens and/or keys for the user. In some embodiments, if the user is a person, then a KYC token can be associated with an active session by the user. In some embodiments, such KYC token can be generated via engine 200 executing a KYC API, as discussed above. In some embodiments, if the user is a company/business, then a KYB token can be associated with the active session of the user via engine 200 executing a KYB API. In some embodiments, if the user is an administrator, owner, or supervisor of a business (e.g., the user is the CEO of a business, f the business is a sole proprietorship or a sole practitioner business), then a KYC token can be registered for the user's session. In some embodiments, a KYC and KYB token can be established for a user, which can be dependent upon the type of activities or business the user is requesting to operate.

In some embodiments, as mentioned above, and discussed in more detail below, a KYD token can be generated for the user via engine 200 executing a KYD API. Accordingly, in some embodiments, the KYD token can avail the user specific banking rails. For example, if the user is a United States user operating within a United States territory, then a KYD token specific to a CC rail can be assigned to the user's account for the session. Similarly, if the user is in Europe, a SWIFT or SEPA KYD token can be applied for the session. In some embodiments, such KYD token can be processed via the KYD API accessing a rails payment gateway, as discussed below.

In some embodiments, tokens (e.g., KYC, KYB and/or KYD) can be applied to a user's account. In some embodiments, such tokens can be, but is not limited to, per session, per login, per request, per a predetermined time interval, according to a type and/or quantity of activity/transactions, specific to types of business partners (e.g., who and what entities is the user transacting with), a location of the user, IP address of the user, type of device being used by the user, type of network used by the user, demographics of the user, business size and/or type of the user, type of bank and/or credit accounts associated with the user, and the like, or some combination thereof.

In Step 504, upon logging in, engine 200 can receive a request from the user. For example, in some embodiments, the request can correspond to, but is not limited to, a transfer of data, a request of a specific type of value (e.g., digital money (e.g., FIAT or crypto) or other data), access to a network resource (e.g., a block/chain in database 110, for example), creation of new data/data models, access to a network resource, and the like, or some combination thereof.

In some embodiments, the request can include information related to, but not limited to, an identify of a type of data, quantity of data, actions to be performed on the data, source of the data, destinations of the data, user identity, demographics of the user, geography of the user, a type and/or quantity of value (e.g., digital money—for example, FIAT and/or Bitcoin) laws and/or regulations associated with activities of the user, KYC and/or KYB information, KYD information, and the like, or some combination thereof.

In Step 506, engine 200 can analyze the request and determine whether the request is permitted. In some embodiments, engine 200 can parse the request and mine for information related to, but not limited to, a requested activity, data information (e.g., type of data, actions requested on the data, and the like, as discussed above in at least Step 504) and demographic and/or geographic information related to the data. In some embodiments, for example, engine 200 can analyze the request and determine that the user is requesting to transfer data housed in location X to user Y with storage in location Z.

According to some embodiments, the demographics and/or geographic information can be extracted from the request, which can govern a determination as to whether such request is authorized by engine 200 and/or the governing laws (e.g., GGM, for example). In some embodiments, engine 200 can access appropriate GGM data to perform the analysis and determination of Step 506. For example, using the above example, engine 200 can identify the laws governing data transactions related to locations X and Z and determine whether such transaction is legal and/or in compliance with the applicable laws and/or privacy standards for a type of transaction being requested to be performed.

In some embodiments, the analysis and determination of Step 506 can be performed via engine 200 executing and/or implementing any type of known or to be known computational analysis technique, algorithm, mechanism or technology, which can include, but is not limited to, a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), etc.), or any other suitable definition of a machine learning model or any suitable combination thereof.

In some embodiments, engine 200 may be configured to utilize one or more AI/ML techniques including, but not limited to, computer vision, feature vector analysis, decision trees, boosting, support-vector machines, neural networks, nearest neighbor algorithms, Naive Bayes, bagging, random forests, logistic regression, and the like. In some embodiments, the AI/ML techniques can be based on and/or include functionality related to, but not limited to, supervised learning, unsupervised learning, semi-supervised learning, feature learning, reinforcement learning, deep learning, graph theory, information theory, heuristic methods, simulation-based methods, dimensionality reduction techniques, optimization methods (e.g., linear, dynamic, non-linear, robust, stochastic, unconstrained, and the like), and the like, or some combination thereof.

In some embodiments and, optionally, in combination of any embodiment described above or below, a neutral network technique may be one of, without limitation, feedforward neural network, radial basis function network, recurrent neural network, convolutional network (e.g., U-net) or other suitable network. In some embodiments and, optionally, in combination with any embodiment described above or below, an implementation of Neural Network may be executed as follows:
a. define Neural Network architecture/model;
b. transfer the input data to the neural network model;
c. train the model incrementally;
d. determine the accuracy for a specific number of timesteps;
e. apply the trained model to process the newly-received input data; and
f. optionally and in parallel, continue to train the trained model with a predetermined periodicity.

In some embodiments and, optionally, in combination with any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination with any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination with any embodiment described above or below, the aggregation function may be a mathematical function that combines (e.g., sum, product, and the like) input signals to the node. In some embodiments and, optionally, in combination with any embodiment described above or below, an output of the aggregation function may be used as input to the activation function. In some embodiments and, optionally, in combination with any embodiment described above or below, the bias may be a constant value or function that may be used by the aggregation function and/or the activation function to make the node more or less likely to be activated.

In some embodiments, Step 506 may further, or optionally, perform the determination based on a smart contract associated with the data and/or type of requested transaction, as discussed above.

Continuing with Process 500, in Step 508, engine 200 can determine a mapping to an entity associated with the data for fulfilling the request. In some embodiments, the mapping can be based on KYD information and/or the applied KYC/KYB information associated with the user (e.g., transferor) and/or the transferee (e.g., in some embodiments, the KYC/KYB and/or KYD information for the transferee can be determined as part of the processing of Step 504, discussed above).

By way of a non-limiting example, a depiction of the mapping between a user (e.g., depicted as being associated with server 302) is provided in FIG. 4. For example, a mapping between a requesting user (e.g., associated with server 302, where in some embodiments, server 302 can be connected to by UE 102 for which the user accesses the ERM 400/network 106) to a location of the data requested to be interacted with/transacted can be established based on KYD for the user and the location. For example, if the data is associated with resources provided by platform 306, then as illustrated, engine 200 can leverage KYD of the user (e.g., server 302) with KYD of the platform 306, as well as the KYC/KYB established between server 302 and engine 200 with system 304. Indeed, the mapping may be in compliance with the GGM, as discussed above and depicted in FIG. 4.

According to some embodiments, Step 508 can involve the establishment of how the user can perform the requested transaction, which can involve accessing the requested data and/or transferring the data to a specified location, as discussed above.

In some embodiments, as discussed above, the data itself can be treated as its own entity with KYD information. Therefore, Step 508 can involve the mapping of the requestor to the data in a similar manner as discussed above.

In Step 510, engine 200 can identify a specific banking rail for executing the requested transaction. In some embodiments, the identification of the banking rail can be based on the mapping of Step 508 and the permission determined in Step 506. For example, as discussed above, if the user is requesting a transaction in Europe, a SEPA rail can be identified. Accordingly, in some embodiments, Step 510 can involve engine 200 identifying the specified rails payment gateway (or gateway logic, used interchangeably). In some embodiments, such access can be enabled via execution of the KYD API, which can enable access to the secure, customized rail infrastructure. Indeed, as discussed above, KYD can correspond to compliance with applicable laws and policies associated with a specific rail and/or infrastructure; therefore, the KYD API can be configured to enable access to engine 200 and/or the user.

According to some embodiments, Step 510 can also involve the transfer of value (e.g., digital money, for example) to a network location associated with the transferee(s). For example, if the user is requesting data from a business entity, then the value can be securely transferred via the identified rail to an account (e.g., wallet) of the entity.

In Step 512, engine 200 can identify the requested data. In some embodiments, this can involve executing a request, search and/or fetch operation via the identified banking rail (of Step 510), where the location of the data can be accessed. As discussed above, this can be executed via the KYD API providing an electronic request that enables integration with the rail's gateway logic.

In Step 514, engine 200 can perform an operation to extract the requested portion of the data. For example, if the data accessed corresponds to ABC data, and the requested data is only for AC, then engine 200 can execute an extraction step to extract AC data. In some embodiments, if the data being requested is ABC, then ABC would be retrieved.

According to some embodiments, Steps 512-514 may be executed by engine 200 (via KYD API, for example), executing a webhook, whereby an audit trail can be generated via interaction of engine 200 with the network location of the data. In some embodiments, usage of the webhook functionality can enable the verification that the user and/or the data are banking rail compliant (e.g., capable and/or verified for transacting over the specific banking rail). In some embodiments, the audit trail may be stored in database 110.

In Step 516, engine 200 can compile the results as an electronic message that is capable of being transmitted via the specific banking rail. According to some embodiments, KYD API can execute to transform the message capable of being transmitted via the banking rail. For example, if the rail being used is a Blockchain, then the compiled results can be compiled as a P2P real-time transaction.

According to some embodiments, the above discussion of Steps 512-516 were discussed in relation to the retrieval of data (e.g., sending value and receiving data). However, as discussed above, the executed requested via ERM 400 is not so limiting, in that, for example, the request can correspond to the transacting of data (e.g., transmitting data to another entity for value). As such, while the operations remain similar, Steps 512-516 can correspond to, either additionally or in the alternative, identifying a location for transmitting the data, and executing the transaction (e.g., sending the data to that location via the identified rail(s), while receiving a transaction confirmation and requested/appropriate value in response via the identified rail(s)).

In Step 518, engine 200 can facilitate storage of the compiled results (e.g., retrieve data and/or transaction receipt/value, for example, as discussed above). In some embodiments, the results can be stored in database 110, for example, as depicted in FIGS. 1 and 4. In some embodiments, when the results correspond to an executed data transaction (e.g., receiving digital money for data), then Step 518 can further involve relaying the received value to an account of the user (e.g., a digital wallet or bank account of the user, for example).

In Step 520, which in some embodiments can occur after Step 518, simultaneously with Step 518 and/or prior to Step 518, the compiled results can be sent to the requestor via the banking rail (identified in Step 510). Thus, for example, the requestor can be in reception of the tangible, machine readable data requested in Step 504 (e.g., digital money and/or data).

In some embodiments, Step 520 may further involve transferring the data to a format that is readable/displayable/renderable via the native environment of the requestor.

According to some embodiments, Steps 518 and/or 520 can trigger engine 200 to create a smart contract for the data. According to some embodiments, as discussed above, the smart contract can provide a set of terms and/or actionable steps that dictate access and/or usage (e.g., whether the data can be shared, modified, and the like, and a time period of such usage, for example) for the data, which can include a pricing structure that corresponds to the access and types of usage. According to some embodiments, for example, the user may be bound to the terms of the smart contract which define the terms of use of the data and/or a token associated with the data.

FIG. 8 is a schematic diagram illustrating a client device showing an example embodiment of a client device that may be used within the present disclosure. Client device 800 may include many more or less components than those shown in FIG. 8. However, the components shown are sufficient to disclose an illustrative embodiment for implementing the present disclosure. Client device 800 may represent, for example, UE 800 discussed above at least in relation to FIG. 1.

As shown in the figure, in some embodiments, Client device 800 includes a processing unit (CPU) 822 in communication with a mass memory 830 via a bus 824. Client device 800 also includes a power supply 826, one or more network interfaces 850, an audio interface 852, a display 854, a keypad 856, an illuminator 858, an input/output interface 860, a haptic interface 862, an optional global positioning systems (GPS) receiver 864 and a camera(s) or other optical, thermal or electromagnetic sensors 866. Device 800 can include one camera/sensor 866, or a plurality of cameras/sensors 866, as understood by those of skill in the art. Power supply 826 provides power to Client device 800.

Client device 800 may optionally communicate with a base station (not shown), or directly with another computing device. In some embodiments, network interface 850 is sometimes known as a transceiver, transceiving device, or network interface card (NIC).

Audio interface 852 is arranged to produce and receive audio signals such as the sound of a human voice in some embodiments. Display 854 may be a liquid crystal display (LCD), gas plasma, light emitting diode (LED), or any other type of display used with a computing device. Display 854 may also include a touch sensitive screen arranged to receive input from an object such as a stylus or a digit from a human hand.

Keypad 856 may include any input device arranged to receive input from a user. Illuminator 858 may provide a status indication and/or provide light.

Client device 800 also includes input/output interface 860 for communicating with external. Input/output interface 860 can utilize one or more communication technologies, such as USB, infrared, Bluetooth™, or the like in some embodiments. Haptic interface 862 is arranged to provide tactile feedback to a user of the client device.

Optional GPS transceiver 864 can determine the physical coordinates of Client device 800 on the surface of the Earth, which typically outputs a location as latitude and longitude values. GPS transceiver 864 can also employ other geo-positioning mechanisms, including, but not limited to, triangulation, assisted GPS (AGPS), E-OTD, CI, SAI, ETA, BSS or the like, to further determine the physical location of Client device 800 on the surface of the Earth. In one embodiment, however, Client device may through other components, provide other information that may be employed to determine a physical location of the device, including for example, a MAC address, Internet Protocol (IP) address, or the like.

Mass memory 830 includes a RAM 832, a ROM 834, and other storage means. Mass memory 830 illustrates another example of computer storage media for storage of information such as computer readable instructions, data structures, program modules or other data. Mass memory 830 stores a basic input/output system (“BIOS”) 840 for controlling low-level operation of Client device 800. The mass memory also stores an operating system 841 for controlling the operation of Client device 800.

Memory 830 further includes one or more data stores, which can be utilized by Client device 800 to store, among other things, applications 842 and/or other information or data. For example, data stores may be employed to store information that describes various capabilities of Client device 800. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 800.

Applications 842 may include computer executable instructions which, when executed by Client device 800, transmit, receive, and/or otherwise process audio, video, images, and enable telecommunication with a server and/or another user of another client device. Applications 842 may further include a client 845 that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, APIs, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a web site, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising;
executing, by a device, via an identity verification application, a login to a network platform;
receiving, by the device, upon the login, a request for data, the request comprising information related to the requestor;
determining, by the device, a network mapping between an entity and the requested data, the entity being associated with a network resource availing the network to the requested data;
identifying, by the device, a banking rail, the identification comprising determining a type of the banking rail for executing an electronic transaction associated with the request;
accessing, by the device, the banking rail via cryptographic token and designed application program interface (API) associated with a type of the cryptographic token;
identifying, by the device, via an electronic transaction processed via the accessed banking rail, the requested data, the identification comprising accessing the requested data from the network resource via the banking rail; and
sending, by the device, the requested data to the requestor via the banking rail.

2. The method of claim 1, further comprising:
extracting, from the network resource, a portion of data that corresponds to the requested data, the network resource comprising a plurality of data that may not correspond to the requested data.

3. The method of claim 1, further comprising:
storing, via communication over the banking rail, the requested data, wherein the sending of the requested data comprises the storage.

4. The method of claim 1, further comprising:
compiling the requested data as a response message, the compilation comprising transforming the data to a format that is at least one of transferable over the banking rail and compliant with capabilities of a system associated with the requestor; and
sending the requested data via the response message.

5. The method of claim 1, further comprising:
analyzing, by the device, the request, and based on the analysis, determining that the request is permitted, the permission being based on the requestor information,
wherein the determination of the network mapping is based on the determination that the request is permitted.

6. The method of claim 1, wherein the identification of banking rail is based on a geographic region associated with the request.

7. The method of claim 1, wherein the cryptographic token and API correspond to know your data (KYD) protocol.

8. The method of claim 7, wherein the banking rail is a Blockchain, wherein the requested data is communicated via a peer-to-peer (P2P) real-time transaction.

9. The method of claim 1, further comprising:
executing a webhook to create an audit trail for the requested data; and
verifying communication of the requested data based on the audit trail.

10. The method of claim 9, further comprising:
storing information related to the audit trail in a database accessible by the device.

11. A device comprising:
a processor configured to:
execute, via an identity verification application, a login to a network platform;
receive, upon the login, a request for data, the request comprising information related to the requestor;
determine a network mapping between an entity and the requested data, the entity being associated with a network resource availing the network to the requested data;
identify a banking rail, the identification comprising determining a type of the banking rail for executing an electronic transaction associated with the request;
access the banking rail via cryptographic token and designed application program interface (API) associated with a type of the cryptographic token;
identify, via an electronic transaction processed via the accessed banking rail, the requested data, the identification comprising accessing the requested data from the network resource via the banking rail; and
send the requested data to the requestor via the banking rail.

12. The device of claim 11, wherein the processor is further configured to:
extract, from the network resource, a portion of data that corresponds to the requested data, the network resource comprising a plurality of data that may not correspond to the requested data.

13. The device of claim 11, wherein the processor is further configured to:
compile the requested data as a response message, the compilation comprising transforming the data to a format that is at least one of transferable over the banking rail and compliant with capabilities of a system associated with the requestor; and
send the requested data via the response message.

14. The device of claim 11, wherein the processor is further configured to:
analyze the request, and based on the analysis, determining that the request is permitted, the permission being based on the requestor information,
wherein the determination of the network mapping is based on the determination that the request is permitted.

15. The device of claim 11, wherein the cryptographic token and API correspond to know your data (KYD) protocol.

16. A non-transitory computer-readable storage medium tangibly encoded with computer-executable instructions that when executed by a device, perform a method comprising:
executing, by the device, via an identity verification application, a login to a network platform;
receiving, by the device, upon the login, a request for data, the request comprising information related to the requestor;
determining, by the device, a network mapping between an entity and the requested data, the entity being associated with a network resource availing the network to the requested data;
identifying, by the device, a banking rail, the identification comprising determining a type of the banking rail for executing an electronic transaction associated with the request;
accessing, by the device, the banking rail via cryptographic token and designed application program interface (API) associated with a type of the cryptographic token;
identifying, by the device, via an electronic transaction processed via the accessed banking rail, the requested data, the identification comprising accessing the requested data from the network resource via the banking rail; and
sending, by the device, the requested data to the requestor via the banking rail.

17. The non-transitory computer-readable storage medium of claim 16, further comprising:
extracting, from the network resource, a portion of data that corresponds to the requested data, the network resource comprising a plurality of data that may not correspond to the requested data.

18. The non-transitory computer-readable storage medium of claim 16, further comprising:
compiling the requested data as a response message, the compilation comprising transforming the data to a format that is at least one of transferable over the banking rail and compliant with capabilities of a system associated with the requestor; and
sending the requested data via the response message.

19. The non-transitory computer-readable storage medium of claim 16, further comprising:
analyzing, by the device, the request, and based on the analysis, determining that the request is permitted, the permission being based on the requestor information,
wherein the determination of the network mapping is based on the determination that the request is permitted.

20. The non-transitory computer-readable storage medium of claim 16, wherein the cryptographic token and API correspond to know your data (KYD) protocol.
